(19) United States
(12) Patent Application Publication
(10) Pub. No.: US 2003/0009308 A1
(43) Pub. Date: Jan. 9, 2003

(54) Instrumented insole

(76) Inventor: Chris Kirtley, Washington, DC (US)

Correspondence Address: ROBERT R. SEABOLD, DIRECTOR, OFFICE OF TECHNOOGY TRANSFER, CATHOLIC UNIVERISITY OF AMERICA, MCMAHON HALL, ROOM 114, WASHINGTON, DC, 20064, US

(21) Appl. No.: 09/887,937

(22) Filed: Jun. 22, 2001

Related U.S. Application Data
(60) Provisional application No. 60/213,981, filed on Jun. 24, 2000.

(51) Int. Cl. G01P 15/00

(52) U.S. Cl. 702/141

(57) ABSTRACT

A combination of sensors, including solid-state gyros and force-sensitive resistors, are mounted in an insole suitable for insertion into a shoe. Data from the sensors is recorded by an in situ Programmable Interface Controller (PIC), logged into on-board EEPROM/Flash memory and relayed to a base station computer via a miniature telemetry transmitter triggered by RFID tagging. Software then uses this data to compute the cadence and ankle power of the subject, as well as other parameters, in order to analyze and assess the gait and activity of the subject.

### CROSS REFERENCE TO RELATED APPLICATIONS

This application includes material described in U.S. Provisional Patent Application No. 60/213,981, entitled “Instrumented Insole,” filed Jun. 24, 2000, and is entitled to the benefits of the filing date thereof.

This application makes reference to U.S. Provisional Patent Application No. 60/213,981, entitled “Instrumented Insole,” filed Jun. 24, 2000. This application is hereby incorporated by reference.

### BACKGROUND OF INVENTION

Computerized Gait Analysis, using video-based techniques, has provided useful insights into the biomechanical cause of gait abnormalities and other movement disorders. One very common finding in a variety of clinical disorders is a reduction in ankle power at push-off (Winter, 1991). This power burst is chiefly responsible for the propulsion of the leg into its swing phase, and is thus highly correlated with the length of stride. A reduction in push-off power is therefore usually accompanied by a shortened stride, giving rise to decreased walking velocity and disability (Gage, 1991). Therefore, accurate measurements of such parameters, as well as many others identifiable in gait analysis, is desirable. Unfortunately, such measurements are complex and require the services of a full gait laboratory, usually having motion analysis equipment and force platforms. The expense and complexity of such equipment is prohibitive for routine clinical rehabilitation, and therefore is generally confined to teh relatively few centers of excellence in universities or major hospitals. The validity of the measurements in such settings is limited due to the artificiality of the environment and the small number of footsteps analyzed. Recently, there has been a move to home and community-based care and rehabilitation, and there is consequently a need for a simple and inexpensive device which can be used to monitor and record the activity of a person over long periods in their own home, street or workplace, or in the office of a physiatrist, podiatrist, physical therapist or sports coach.

The development of miniature solid-state gyro and accelerometer sensors has provided a simple and accurate method for measuring the motion of limb segments during movement (Tong & Granat, 1999). In addition, thin force sensors can be made from conductive polymer or piezo-electric film (Neville et al, 1995). The present invention provides a novel combination of such sensors in a removable shoe insole, together with other electronic components, which can be inserted into the shoe of a person or patient in need of or desiring gait analysis or monitoring.

In many Home Care Technology (HCT) applications, data is collected from one or more sensors and either logged to memory or transmitted via infra-red or radio telemetry to a base station for further relay via the internet. There is, however, a surprising lack of inexpensive and simple solutions for data-logging and telemetry currently available. The present invention therefore also provides a versatile module capable of fulfilling a broad selection of HCT applications by combining the use of a Programmable Interface Controller (PIC), serial Electrically Eraseable Read Only Memory (EEPROM) and Surface Acoustic Wave (SAW) transceiver technology.

Prior examples of the use of electronic devices for the measurement of movement and bodily function include: U.S. Pat. No. 4,019,030: Step-counting shoe (Tamiz); U.S. Pat. No. 4,578,769: Device for determining the speed, distance traversed, elapsed time and calories expended by a person while running (Frederick); U.S. Pat. No. 5,899,963: System and Method for Measuring Movement of Objects (Hutchings); a “dance shoe” developed by Paradiso (MIT Media Lab), that incorporates various sensors and is used to control computer generated music and enhance dance performances; U.S. Pat. No. 5,875,571, an insole pad having step-counting device using a pressure-sensitive sensor (Yukawa); U.S. Pat. No. 4,814,661: Systems for measurement and analysis of forces exerted during human locomotion (Ratzlaff); U.S. Pat. No. 4,745,930, a force sensing insole for electro-goniometer; and U.S. Pat. No. 5,471,405: Apparatus for measurement of forces and pressures applied to a garment (Marsh). Most of these devices are limited to force measurement, and are aimed at simple step-counting for sports applications. None of them are concerned with medical diagnosis or home-based care. Further, none of them are incorporated into a removable insole which may be moved from shoe to shoe. Even further, none of them provide the convenient and low cost solution provided by the present invention.

The invention relates to the fields of podiatry, sports science, biomechanics, footwear design, rehabilitation, and electronic measuring devices. The invention is a self-contained system within a soft shoe insole, suitable for insertion into a shoe, consisting of a battery-operated microcontroller, memory, data transceiver and various sensors, such as solid-state gyros and force-sensitive resistors, capable of recording and monitoring many aspects of foot function and analyzing locomotor and other activities. Foot and ankle angular velocities may be simultaneously recorded. This data may be used to compute the cadence and ankle power of the subject, as well as other parameters, in order to analyze and assess the gait and activity of the subject.

### BRIEF DESCRIPTION OF DRAWINGS

The present invention will be best understood in reference to the accompanying drawings, in which:

FIG. 1 is a diagram showing top and orthagonal views of one embodiment of the invention, including the positions of the mounted components.

FIG. 2 is a diagram showing one embodiment of a means for inductively recharging a non-removable battery embedded within the present invention.

FIG. 3 is wiring diagram showing one embodiment of a wiring scheme for a micro-controller board of the present invention.

### DETAILED DESCRIPTION

The differences between my invention and the other technology, and the advantages of my invention over that technology, variously include the following: mounting of sensors in an insole rather than in the shoe itself; use of the sensor data for calculation of gait analysis parameters (e.g. ankle power); utilization of a gyro sensor; use of an accelerometer rather than a gyro sensor, and infra-red rather than rf, and lack of a datalogging function described in either #1 or 2. The unique advantage of the combination of radio telemetry for real-time recording (triggered by RFID tagging) with datalogging to record data when the subject is out of range of the base receiver has not been previously described, and is likely to prove useful for many other applications.

A combination of sensors, including solid-state gyros and force-sensitive resistors, are mounted in an insole suitable for insertion into a shoe. Data from the sensors is recorded by an in situ Programmable Interface Controller (PIC), logged into on-board EEPROM/Flash memory and relayed to a base station computer via a miniature telemetry transmitter triggered by RFID tagging. Software then uses this data to compute the cadence and ankle power of the subject, as well as other parameters, in order to analyze and assess the gait and activity of the subject. A total system concept consists of various sensors (including but perhaps not limited to) one or more Murata gyros and FSRs, along with a miniature datalogger and radio telemetry unit, all mounted within a standard flexible insole around 4-5 mm thick. A head (cap) mounted gyro system for the assessment of head rotations for balance and vestibular monitoring, is also envisioned. An RFID tag system (e.g. Microchip MCRF250) may be useful for triggering download of data to a base station receiver. Power will ideally be provided by a rechargeable Lithium button cell (30-100 mAh), and this may be supplemented by a piezo-electric charging mechanism using the energy of footfalls.

Solid-state gyro sensors offer several advantages for use in rehabilitation engineering. They are small, resilient, relatively cheap, and require very little additional electronic componentry (merely a 3V power supply). They are thus eminently suitable for mounting inside the shoe. This study has shown that such an arrangement can provide very useful information concerning the angular velocity of foot and ankle during the important push-off phase of gait.

The information obtained could be used in several ways. Firstly, the cyclical velocity spikes could be used to detect and count steps, and calculate cadence. When combined with a miniature force sensor, also mounted in the insole, it may also be possible to estimate power generation during the important push-off phase. This would provide a simple clinical tool with which to quantify gait performance and diagnose disorders in which push-off is reduced.

The invention may be best made in the following manner. Surface mount fabrication on a small flexible printed circuit board (PCB) in a modular form suitable for insertion into off-the-shelf or purpose-made shoe insoles. The chief considerations are size (especially thickness) and durability, since the device must withstand substantial cyclical loading during walking. The insole should be flexible but of sufficient resilience and firmness, e.g. Pelite, EVA, polyurethane (Poron, Cleron), PVC. Insoles could be manufactured in a range of sizes or alternatively be cut to size and shape at the time of fitting. Software will need to be developed which is user-friendly and specific to the application (e.g. clinical, domestic, ergonomic). The batteries will ideally be charged by wireless coupling, and possibly by piezo-electric power generation from footfalls.

The potential uses of the invention are many, and include, but are not limited to:(1) Medical diagnosis—used by physical therapists, physiatrists etc. to diagnose walking problems, such as weak push-off disorders, excess foot pronation/supination; (2) Monitoring and periodic assessment of disorders such as those above, in the clinic, home, street or workplace. Evaluation of the effects of treatment, such as medication, physical therapy, Botox injection, surgery, etc.; (3) Assessment and prescription of functional foot orthoses (FFOS, Orthotics) for the treatment of common foot conditions, such as excess pronation/supination, plantar faschiitis, diabetic ulcer/neuropathy; (4) Activity monitoring in the elderly or disabled, fall prevention; (5) Recording and analysis of exercise activity such as jogging, cycling, and walking; (6) Appropriate selection of shoes in retail outlets, wher currently observational analysis by the shop assistant is used with or without additional foot scanning equipment; (7) Diagnosis, monitoring and alerting of ergonomic problems, such as excessive loading; (8) Treatment of various disorders by biofeedback, sounding of alarms, control of movement of air/fluid between sacs by valves; (9) Remote control of and interaction with home appliances, such as television, computer/video games and vehicles; (10) Operation of musical instruments and associated devices; (11) Monitoring of motion of subjects, such as disabled or psychiatric patients, children or prisoners; (12) Enhancement of play by interaction with suitably receptive toys for children and intellectually disabled subjects. The combination of PIC-EEPROM-RFID tagging for data logging/management and telemetry could also find use in many other applications in the biomedical, zoological and remote sensing fields.

The following examples illustrate the potential uses

### EXAMPLES

### Example 1

Methodology: The device to be developed is shown in FIG. 9. The force sensors are placed along the insole, such that they will detect force applied during the push-off phase. The solid state gyro (Type ENC-03JA, Murata, Japan) is mounted nearby (its location is not critical) to detect the angular velocity of the foot. Since the distance of the force sensors to the ankle-joint is known from the dimensions of the insole, the moment of force and angular velocity of the foot can be calculated. A necessary assumption is that the shank (lower-leg) of the subject is relatively stationary, with the foot angular velocity then being a close approximation of the ankle velocity. This is normally the case in both normal and pathological gait.

Electronics and Signal Processing: The force sensors require charge-amplifier. The charge from each sensor can be multiplexed before amplification, so that only a single amplifier is required, which will be initially housed in a small box on a strap around the lower leg of the subject. It may later be incorporated into the insole. Processing of the two signals can be best performed by a Programmable Integrated Circuit (PIC16F84), which is small but versatile. The data will be stored on the insole using on-board RAM memory. It will then be downloaded to a PC by connecting to a small port on the insole. The software will graph the foot velocity, force and derived ankle powers well as calculating the tie integral of the power, i.e. the total work done during the A2 burst.

Evaluation: In order to assess the validity and reliability of the insole, its output will be compared to the A2 power measured during a standard 3D computerized gait analysis, using the Vicon motion analysis system at the National Rehabilitation Hospital. Five normal subjects will be recruited and will walk with the insole in place, with retro-reflective markers on the toe, malleolus, shank, femoral condyle, thigh and pelvis (according to the Vicon Clinical Manager model). The integral of the positive portion of the ankle power curve will be used to calculate the work done during push-off, which will be compared with the output of the insole. A repeated measure ANOVA will be used to derive an intra-class correlation coefficient.

### Example

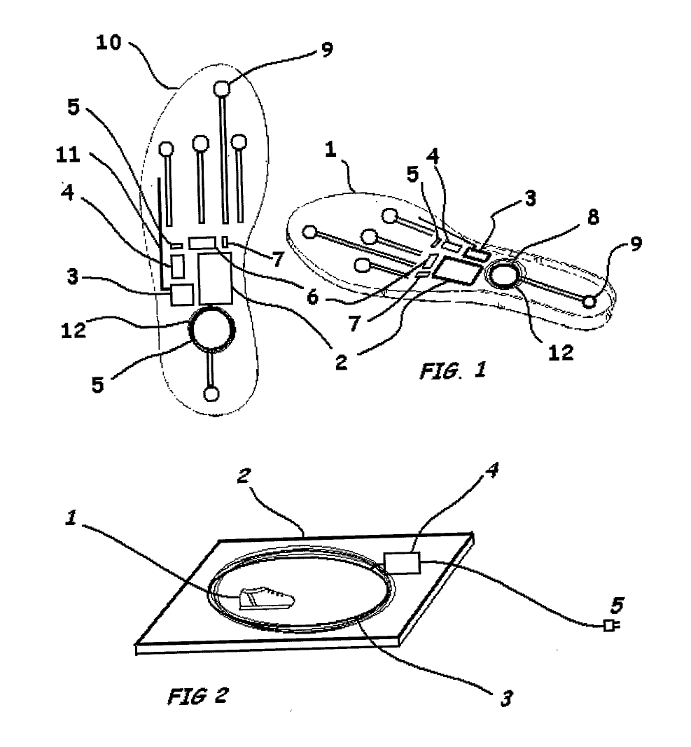

Method: The solid-state gyro sensor (Type ENC03JA, Murata, Japan) was mounted in a Pelite insole (FIG. 1). Its location in the instep was selected so as to be unaffected by flexing of the sole, and it was aligned transversely, such that it was most sensitive to angular velocity about the talo-crural joint. The subject then underwent a standard 3D gait analysis, using a Vicon motion analysis system (Oxford Metrics, Oxford, UK). The Vicon Clinical Manager (VCM) model (5) was used, with markers on the second metatarsal, lateral malleolus and lateral femoral condyle determining the foot and ankle joint angles. The output of the gyro sensor was recorded simultaneously. The subject was asked to walk slowly (0.65 m/s), in order to simulate a pathological gait. Several steps were recorded.

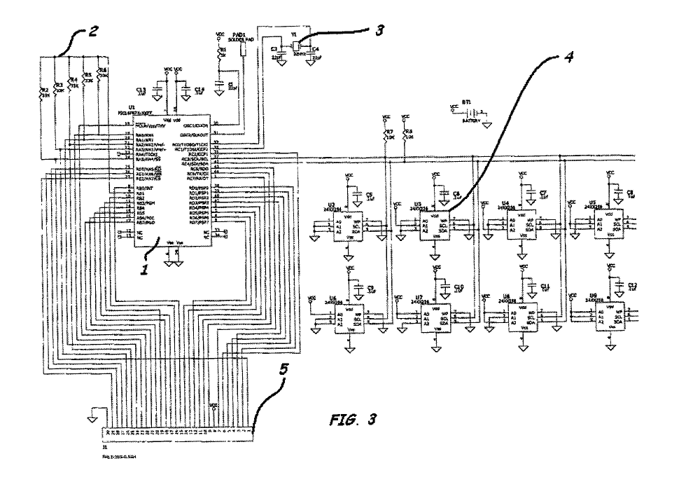

Results: The output of the gyro sensor closely tracked the angular velocity of the foot, as measured by the Vicon motion analysis system (FIG. 2). The objective of this study was to compare the output of a gyro sensor mounted in an insole with the angular velocity of the foot and ankle as measured by a 3D gait analysis system. Of particular interest was the correlation between gyro and ankle velocity during push-off. motion analysis system (FIG. 2). When compared with the ankle joint velocity, there were large discrepancies during swing phase. However, during stance phase, and particularly during the push-off power-generating phase, the gyro signal was very well correlated with ankle velocity (FIG. 3). A linear regression between the gyro signal and the ankle angular velocity during the push-off phases (FIG. 4) revealed a correlation of 0.93

A specific objective of this invention is to provide a means for ambulatory recording of various measures of locomotor function, including forces under the foot, angular velocity and acceleration of the foot, over prolonged periods of time.

Another specific objective of this invention is to allow these variables to be monitored real-time via radio telemetry with minimal encumbrance to the person.

A further specific objective of this invention is to provide a means for activity monitoring over prolonged periods of time, with detection of various states of action, including detection of falls in the elderly or disabled.

A further specific objective of this invention is to provide a means for monitoring and warning of ergonomic and workplace hazards, such as excessive loading.

A further specific objective of this invention is to record various aspects of foot function in order to assess podiatric disorders such as plantar fasciitis, pes planus (flat foot), talipes equino-varus (club foot) and those consequent to degenerative diseases such as arthritis and diabetes mellitus. The device is also intended for assessment and prescription of functional foot orthoses, in which it may be incorporated, for treatment of these conditions.

A still further objective of this invention is to provide a means for appropriate selection of shoes in retail outlets for people with hyper-pronation or supination conditions.

A further objective of this invention is to provide a means for treatment of such disorders by vibratory or electrical biofeedback, sounding of alarms, and control of movement of air/fluid between sacs by valves.

A further objective of this invention is to provide these functions in a device that is self-contained within a shoe insole, which is light in weight and convenient to use, able to be inserted in a variety of different shoes.

A still further objective of this invention is to provide a versatile miniature electronic system capable of data-logging and telemetry of a wide variety of biological signals for use in home-based care.

A further objective of this invention is to provide a means for recording and comprehensive analysis of sports and exercise activities such as jogging, cycling, and walking.

A still further objective of this invention is to provide a means for wearable remote control of and interaction with, home appliances, such as television, computer/video devices and vehicles.

A further objective of this invention is to provide a means for enhancement of play by interaction with suitably receptive toys for children and people with intellectual disability.

A further objective of this invention is to provide a means for monitoring the movement of subjects around a building, such as workers, disabled or psychiatric patients, children or prisoners. A final objective of this invention is to provide a means for detection and recognition of persons. Each insole is allotted a unique address along with various attributes and so can be recognized by another insole seeking desired parameters. This may be used to locate persons with similar interests in a public place, for example, with vibration providing a signal to the wearer.

### SUMMARY OF THE INVENTION

In accordance with one aspect of the invention, an insole is instrumented with electronic devices that measure various biological signals. The data from several sensors is stored in onboard memory and downloaded to a base station personal computer via radio-frequency telemetry when within range. Software in the receiving base station uses the data to compute various measures of locomotor and foot function, as well as detecting the state of activity of the person. In accordance with another aspect of the invention, the insole is completely self-contained, and contains a rechargeable battery with charging by inductive coupling from a coil embedded in a mat, rug or carpet.

In accordance with another aspect of the invention, the data obtained can be used in diverse ways for medical diagnosis, monitoring of activity of the person, evaluation of therapeutic interventions, environmental control of various appliances.

### DETAILED DESCRIPTION OF THE INVENTION

An embodiment of the system is shown in FIG. 1. A light weight flexible insole 1, made from orthotic material such as ethyl-vinyl-acetate (EVA), Plastazote, Microcell Puff, or Pelite, provides a mounting for a circuit board 2, miniature radio transceiver module (as exemplified by RF Monolithics DR3000) 3 and rechargeable battery (3 volts, such as the Lithium Vanadium Pentoxide type VL2320, by Panasonic) 8. The circuit board 2 incorporates a Programmable Interface Controller (such as Microcip PIC 16F877) and nonvolatile memory (Electrically-Eraseable Read Only Memory, EEPROM, e.g. Microchip 24FC256, or Flash memory, e.g. Toshiba TC58V64AFT) along with associated components. Two piezo-electric gyroscope sensors 3 and 6 (Murata ENC-03J) sense angular velocity about the longitudinal and transverse axes of the insole, respectively, while two bi-axial accelerometers 5 and 7 (Analog Devices ADXL202) sense acceleration in the three orthogonal directions (longitudinal, transverse and vertical). Pressure sensors 9, (such as Flexiforce made by Tekscan, or IESF-R-5 made by CUI STACK Inc.) of which there be several distributed over the insole at points of interest, measure the force on the sole at these locations. All the sensors and the radio transceiver are mounted on a flexible Printed Circuit Board 10, of the same shape and size as the insole, and also provides a whip antenna 11 for the transceiver. This is connected to the microcontroller board 1 by a small edge connector. A coil 12 around the battery enables recharging of the battery by an arrangement shown in FIG. 2. The shoe containing the instrumented insole is placed on a mat 1 overnight, in which is mounted a primary coil 3, driven by a high-frequency charging circuit 4 supplied by current from the domestic alternating current electricity supply 5. A voltage is thereby induced in the secondary winding around the battery within the insole. By this means the insole can be made completely self-contained and sealed, thereby protecting the electronics inside from sweat and other potentially harmful substances. In another embodiment of the invention, a charging mechanism is used to charge the battery by using the energy gained from compressing piezo-electric film at each footfall.

The circuit for the micro-controller board is shown in FIG. 3. The micro-controller 1 receives analog inputs from up to eight sensors 2, and digital inputs from the accelerometers. This sampling is driven by the watch crystal 3, and data are stored in the serial EEPROM 4. A connector 5 facilitates connection to the flexible printed circuit board, on which is mounted the various sensors and telemetry transceiver.

What is claimed is:

1. a device comprising a soft, flexible insole, means for measuring acceleration and rotation of said insole embedded within said insole, means for capturing and storing data of acceleration and rotation output from said measuring means, and means for relaying data captured by said capturing and storing means to an external data receiver.
